(19) United States
(12) Patent Application Publication
(10) Pub. No.: US 2026/0046237 A1
(43) Pub. Date: Feb. 12, 2026

(54) SYSTEMS AND METHODS IMPLEMENTING CONTROLLER-BASED MULTIPLE DOMAIN AUTOMATIC NEXT-HOP RESOLUTION (ANR) IN TRAFFIC ENGINEERING NETWORKS

(71) Applicant: CIENA CORPORATION, Hanover, MD (US)

(72) Inventors: Amila Pradeep Kumara Tharaperiya Gamage, Stittsville (CA); Muthurajah Sivabalan, Kanata (CA); Prabhu Vaithilingam, Ottawa (CA)

(73) Assignee: CIENA CORPORATION, Hanover, MD (US)

(21) Appl. No.: 18/800,509

(22) Filed: Aug. 12, 2024

(51) Int. Cl. H04L 45/02; H04L 45/24; H04L 45/42

(52) U.S. Cl. CPC H04L 45/04; H04L 45/24; H04L 45/42

(57) ABSTRACT

Aspects of the subject disclosure may include, for example, in response to a Border Gateway Protocol (BGP) update from an egress provider edge router connected to a destination customer network, receiving a request for an end-to-end SR policy or an end-to-end path from an ingress provider edge router, where the BGP update includes a prefix of the destination customer network and a first color; using color mapping data, determining a first domain associated with the first color and determining a second color to be associated with a second domain and mapped to the first color, where a color is a numerical value associated with a network intent of a domain, the color mapping data define mappings between different colors associated with different domains, and the mapped first color and second color enable identification of a first intent and a second intent that belong to the first domain and the second domain, respectively; and generating the end-to-end path reflecting each definition of the first and the second intents identified by the first color in the first domain and the second color in the second domain. Other embodiments are disclosed.

### FIELD OF THE DISCLOSURE

The subject disclosure relates to systems and methods implementing controller-based multiple domain automatic next-hop resolution (ANR) in traffic engineering networks.

### BACKGROUND

Automatic next-hop resolution (ANR) (also known as On-Demand Next-hop (ODN)) automates provisioning of transport for carrying services, such as L3VPN and EVPN, using Segment Routing (SR) policies. With ANR, an egress provider edge router (egress-PE) advertises a prefix with a color. This color identifies an intent associated therewith. The intent includes a set of constraints and parameters based on which SR policies are instantiated at ingress-Provider Edge Router (ingress-PE)'s and border nodes (e.g., Autonomous System Boundary Router (ASBR)) to provide end-to-end transport for the service.

The multi-domain ANR technique may face a few issues. For a given service, a same color value may not be used across all the domains as a color value advertised by the egress-PE may have already been used for a service with a different intent in another domain. For a given service, different domains, owned by different network operators, could be configured using different conventions and a same intent definition (e.g., the same set of constraints) could not be used to represent an intent across all the domains. For example, different domains could configure links/nodes with different Shared Risk Link Group (SRLG) and/or affinity bit values.

### BRIEF DESCRIPTION OF THE DRAWINGS

Reference will now be made to the accompanying drawings, which are not necessarily drawn to scale, and wherein:

FIG. 1 is a network diagram illustrating an exemplary, non-limiting embodiment of a controller-based multiple domain automatic next-hop resolution (ANR) in accordance with various aspects described herein.

FIG. 2 depicts an illustrative embodiment of controller operations in accordance with various aspects described herein.

FIG. 3 is another network diagram illustrating an exemplary, non-limiting embodiment of a controller-based multiple domain automatic next-hop resolution (ANR) in accordance with various aspects described herein.

FIG. 4 an illustrative embodiment of other controller operations in accordance with various aspects described herein.

FIG. 5 depicts an illustrative embodiment of a method in accordance with various aspects described herein.

FIG. 6 depicts an illustrative embodiment of another method in accordance with various aspects described herein.

FIG. 7 depicts an illustrative embodiment of yet another method in accordance with various aspects described herein.

FIG. 8 is a block diagram of an example, non-limiting embodiment of a computing environment in accordance with various aspects described herein.

### DETAILED DESCRIPTION

The subject disclosure describes, among other things, illustrative embodiments for systems and methods implementing controller-based multiple domain automatic next-hop resolution (ANR) in traffic engineering networks. The systems and methods provision end-to-end transport paths for ANR by a controller or a set of hierarchical controllers. The controllers may contain Path Computation Element (PCE) functionality. The systems and methods may not depend on Border Gateway Protocol Label Unicast (BGP LU). The systems and methods can compute, using the controller or the set of hierarchical controllers, end-to-end SR policy paths across multiple domains, are able to provide end-to-end disjoint paths, and enhance scale by eliminating the BGP LU. Other embodiments are described in the subject disclosure.

One or more aspects of the subject disclosure are directed to a device including a processing system including a processor, and a memory that stores executable instructions that, when executed by the processing system, facilitate performance of operations. The operations include maintaining color mapping data containing a mapping between a first color associated with a first domain and a second color associated with a second domain, wherein a color is a numerical value associated with a network intent of a domain, and the mapped first and second colors signify and represent the network intent of the first domain and the second domain, respectively; in response to a Border Gateway Protocol (BGP) update from an egress provider edge router (egress-PE) connected to a destination customer network, receiving a request for an end-to-end segment routing (SR) policy from an ingress provider edge router (ingress-PE), where the BGP update includes a prefix of the destination customer network and the second color and is received at the ingress-PE; using the color mapping data, determining the first color corresponding to the second color and determining the first color to be associated with the first domain; and providing the end-to-end SR policy reflecting the network intent to the ingress-PE.

One or more aspects of the subject disclosure are directed to a non-transitory machine-readable medium, including executable instructions that, when executed by a processing system including a processor, facilitate performance of operations. The operations comprising maintaining color mapping data defining mappings of different colors associated with different domains, where the different domains correspond to different autonomous systems, and wherein a color is a numerical value associated with a network intent of a domain and the different colors are mapped to be used as keys to identify each corresponding network intent of the different domains; in response to a Border Gateway Protocol (BGP) update from an egress provider edge router (egress-PE) connected to a destination customer network, receiving a request for an end-to-end segment routing (SR) policy indicative of an end-to-end path from an ingress provider edge router (ingress-PE), where the BGP update includes a prefix of the destination customer network and a first color; using the color mapping data, determining a first domain associated with the first color and determining a second color to be associated with a second domain and mapped to the first color, and generating the end-to-end SR policy reflecting each network intent definition configured in the first domain using the first color and the second domain using the second color and providing the end-to-end SR policy to the ingress-PE.

One or more aspects of the subject disclosure are directed to a method including, in response to a Border Gateway Protocol (BGP) update from an egress provider edge router (egress-PE) connected to a destination customer network, receiving, by a processing system including a processor, a request for an end-to-end path from an ingress provider edge router (ingress-PE) where the BGP update includes a prefix of the destination customer network and a first color; using color mapping data, determining, by the processing system, a first domain associated with the first color and determining, by the processing system, a second color, associated with a second domain and mapped to the first color, wherein a color is a numerical value associated with a network intent of a domain, and wherein the color mapping data define mappings of different colors associated with different domains, and the mapped first color and second color enable identification of a first intent and a second intent that belong to the first domain and the second domain, respectively; and generating, by the processing system, the end-to-end path reflecting each definition of the first and the second network intents identified by the first color in the first domain and the second color in the second domain.

Automatic Next-hop Resolution (ANR) is a feature that allows a computer to find the most direct route to another computer on a distributed network. ANR (also known as ODN) automates provisioning of transport for carrying services, such as L3VPN and EVPN, using Segment Routing (SR) policies. With ANR, an egress provider edge router (egress-PE) advertises a prefix with a color. The color is a numerical value (e.g., 32 bits, 64 bits, etc.) associated with a network intent (e.g., low-cost, low-delay, avoid some resources, 5G network slice, etc.).

Intent is a set of operational goals that a network should meet and outcomes that a network is supposed to deliver, defined in a declarative manner without specifying how to achieve or implement them. Section 2 of [RFC9315] of Internet Engineering Task Force. The intent can be translated to a set of constraints and parameters that are configured in an Intent Definition, based on which SR policies are generated. The color identifies a set of constraints and parameters based on which SR policies are instantiated at an ingress provider edge router (ingress-PE)'s and border nodes to provide end-to-end transport for the service.

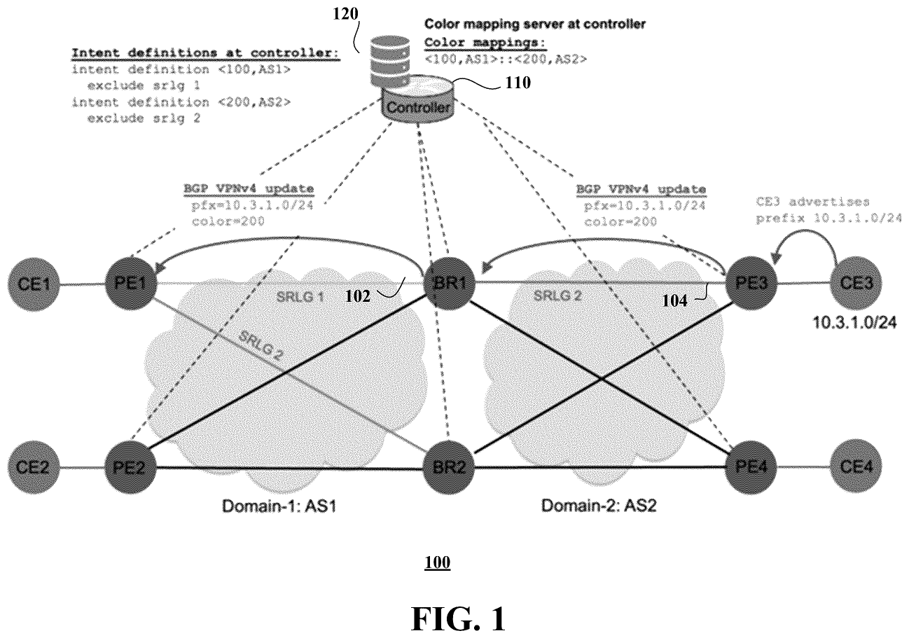

FIG. 1 is a network diagram illustrating an exemplary, non-limiting embodiment of controller-based multiple domain automatic next-hop resolution (ANR) in accordance with various aspects described herein. In various embodiments, a network 100 includes two autonomous systems (AS), AS1 and AS2, which correspond to Domain-1 and Domain-2, respectively. The present disclosure is not limited to two autonomous systems/two domains which are described for convenience of description purposes. The network 100 further includes customer edge routers CE1, CE2, CE3 and CE4, and provider edge routers PE1, PE2, PE3 and PE4. The Domain-1 and Domain-2 in the network 100 are connected via border node routers BR1 and BR2. The border node routers BR1 and BR2 can be implemented with an autonomous system boundary router (ASBR). The ASBR is a router that runs multiple protocols and serves as a gateway to routers outside of one domain, thereby permitting communication among different autonomous systems or routing domain. As depicted in FIG. 1, customer sites (i.e., CE1, CE2, CE3, CE4) are connected to provider sites (PE1, PE2, PE3, PE4).

In various embodiments, the network 100 includes a controller 110 which includes a color mapping server 120. The controller 110 is implemented as path computation element (PCE) and performs PCE functionality. The PCE is a system component, application, or network node capable of determining and finding a suitable route for conveying data between a source and a destination. The PCE can be an external server application or a network component such as a headend router.

In IP/MPLS networks, the headend router computes the path for traffic based on the demands of the network. The headend router or the network device computing the path may not have a powerful enough CPU to compute complex path requirements or enough memory to maintain a large TE Database (TED), which holds the topology and resource information of its domain. The PCE allows for faster updating of path computation policies, reduces costs, and provides the ability to move away from path computation algorithms that are hardcoded into router vendor hardware. The PCE addresses TE limitations in large, multi-domain networks where path computation is complex due to TE's limited visibility into neighboring domains. The PCE can be designed to work with other PCEs for a global view of the domain and inter-domain routing requirements.

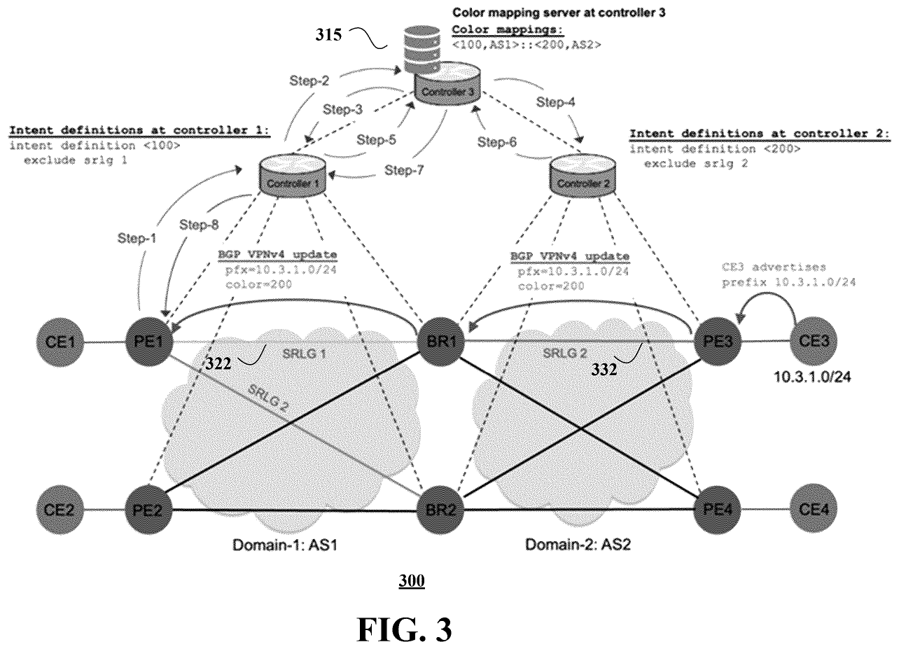

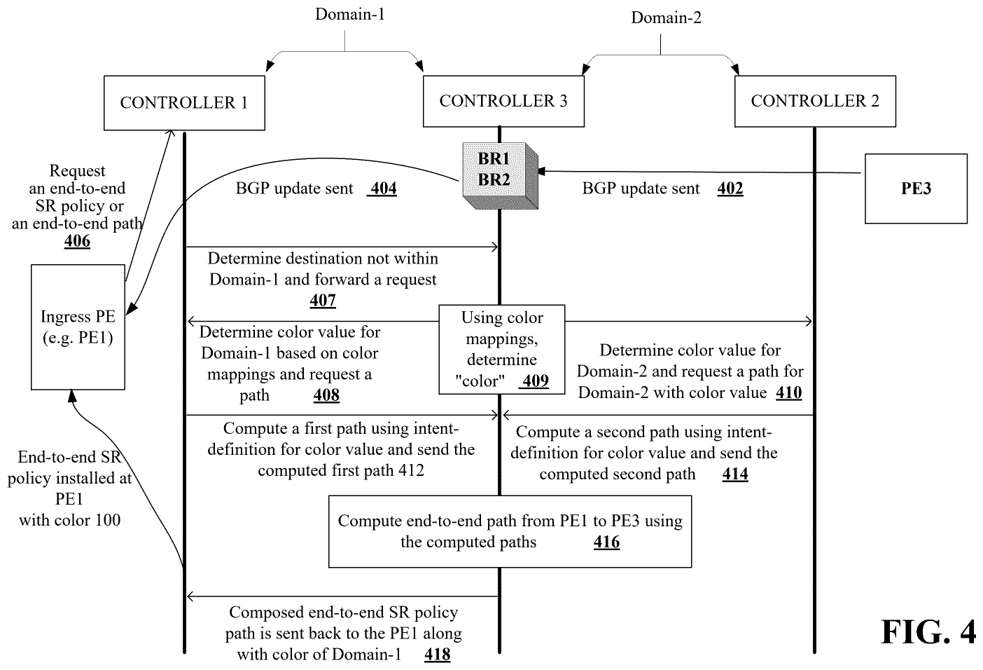

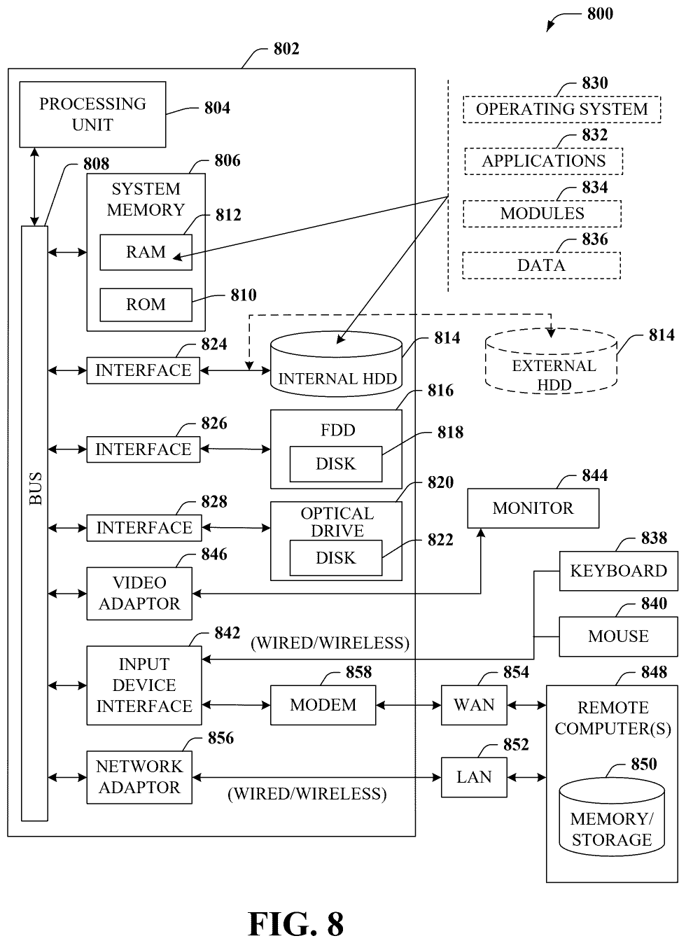

In various embodiments, the controller 110 is a single, centralized PCE and performs path computations for domains. The controller 110 can compute end-to-end SR policy paths across multiple domains and provide end-to-end disjoint paths, and enhance by eliminating BGP LU. As one example, the controller 110 can be implemented with computing environment as described below in connection with FIG. 8. Additionally, or alternatively, the controller 110 can be implemented with a plurality of controllers, which may be implemented as a set of hierarchical controllers, as depicted in FIGS. 3-4.

In various embodiments, the controller 110 stores intent definitions. By way of example only, intent (e.g., a requirement, a constraint, etc.) is to setup a transport from CE1 to access 10.3.1.0/24 network at CE3, without traversing a first link 102 (i.e., link between PE1 and BR1) and a second link 104 (i.e., link between BR1 and PE3). As another example, PE3 has been configured to advertise a VPNv4 route for prefix 10.3.1.0/24 with “Color 200.” As depicted in FIG. 1, intent definitions such as “<100, AS1> excludes srlg1”, “<200, AS2> exclude srlg2”, etc. may be configured and/or stored at the controller 110. As descried above, the intent represents the requirements a user/customer has for their services. The intent definition is a set of constraints that have to be configured in a network in order to achieve that intent. For a given intent, network engineers may have to configure different intent definitions for different domains. In the above example, such as srlg1, srlg2, the intent may be the same or substantially same for both domains AS1 and AS2, but the configurations in each domain may result in two different intent definitions with different constraints. Whether the intent definitions are same or different depends on how each network domain is configured. Different configurations may not matter as color mappings can be used to identify relevant intent definition for a given domain, as described below in detail.

To be able to provision transport using ANR across Domain-1 and Domain-2, Domain-2 should either not have an intent definition configured for “Color 200” (in this case, a new one can be configured) or have an intent definition configured for “Color 200” that satisfies the intent of “Color 200.” To compute a path from PE1 to PE3, the same intent definition may not be used in Domain-1 and Domain-2. This is because, in Domain-1, links with Shared Risk Link Group (SRLG) value 1 (i.e., SRLG 1) should be excluded, while in Domain-2, the links with SRLG value 2 (i.e., SRLG-2) should be excluded. The Shared Risk Link Group (SRLG) is a set of links sharing a common resource, which affects all links in the set if the common resource fails. These links share the same risk of failure and are considered to belong to the same SRLG. As one example, links sharing a common fiber are said to be in the same SRLG because a fault with the fiber may cause all links in the group to fail.

In various embodiments, the network 100 is configured such that each domain (i.e., Domain-1, Domain-2) defines its own intent definition and a color. For a given color, each domain can define its own intent definition including a set of constraints and parameters based on the conventions used for configuring the domain. This intent definition will be used for computing SR policies or paths for SR policies by the controller 110 over the domain. By way of example only, these domain specific intent definitions could be identified by <color, domain>. Color mappings could be in the form of <color 1, domain 1>maps to <color 2, domain 2 >maps to <color 3, domain 3 >, and so on. Domains could be identified by Autonomous System (AS) numbers or by other parameters of the domain, such as <100, AS1>, <200, AS2>, etc. The domain specific intent definitions will be maintained at the controller 110, in particular, at the color mapping server 120. As depicted in FIG. 1, the color mapping server 120 stores color mappings, such as <100, AS1>, <200, AS2>, etc.

In various embodiments, for a given intent, each domain may use its own color. The color mapping server 120 resides within the controller 110 and maintain mappings between colors. When a transport across multiple domains is setup, color advertised by an egress-PE (e.g., PE3) via a BGP update is specific only to the domain which the egress-PE (e.g., PE3) belongs to. Other domains over which the transport is setup could have different colors that are mapped to the color advertised by the egress-PE (e.g., PE3). In other words, color associated with the same intent may vary based on domains, such as <100, AS1>, <200, AS2>, etc..

In various embodiments, when an ingress-PE (e.g., PE1) requests a SR policy or a path for a SR policy from the controller 110, the ingress-PE will send a color value and a domain number (e.g., AS number) received from the egress-PE (e.g., PE3) to the controller 110. Using this information, the color mapping server 120 at the controller 110 will determine colors for other domains. Using the example depicted in FIG. 1, PE1 requests the SR policy from the controller 110, after receiving <200, AS2>from PE3, and sends <200, AS2>to the controller 110. The controller 110 sends the color of the ingress-PE's domain, along with computed end-to-end SR policy, to the ingress-PE. The ingress-PE (e.g., PE1) will install the end-to-end SR policy using the color received from the controller 110. The color values in BGP updates are not modified by border routers (i.e., BR1, BR2) as the updates propagate in the network 100.

In various embodiments, different domains will possibly have different sets of constraints for the path. Therefore, it is not possible to use existing path computation mechanisms which enforce the same set of constraints on the links/nodes belonging to all the domains. The controller 110 includes a topology database that is populated by collecting topology information of each domain via existing protocols, such as BGP-Link State (BGP-LS). BGP-LS is an Address Family Identifier (AFI) and Sub-address Family Identifier (SAFI) defined to carry interior gateway protocol (IGP) link-state database through BGP routing protocol. Accordingly, BGP-LS delivers network topology information to topology servers and Application Layer Traffic Optimization (ALTO) servers. The topology database contains domain information (e.g., AS number) of each link and node.

When paths are computed across multiple domains, the controller 110 enforces constraints on links/nodes as follows. For each link/node that is being considered to be on the path, first, the domain information (e.g., AS number) of the link/node is obtained from topology database (e.g., AS1, AS2). Second, intent definition for <color, domain> of the link/node is obtained (e.g., <100, AS1>, <200, AS2>), where color is the color for the domain as described above. Third, the set of constraints in the intent definition is enforced on the link/node.

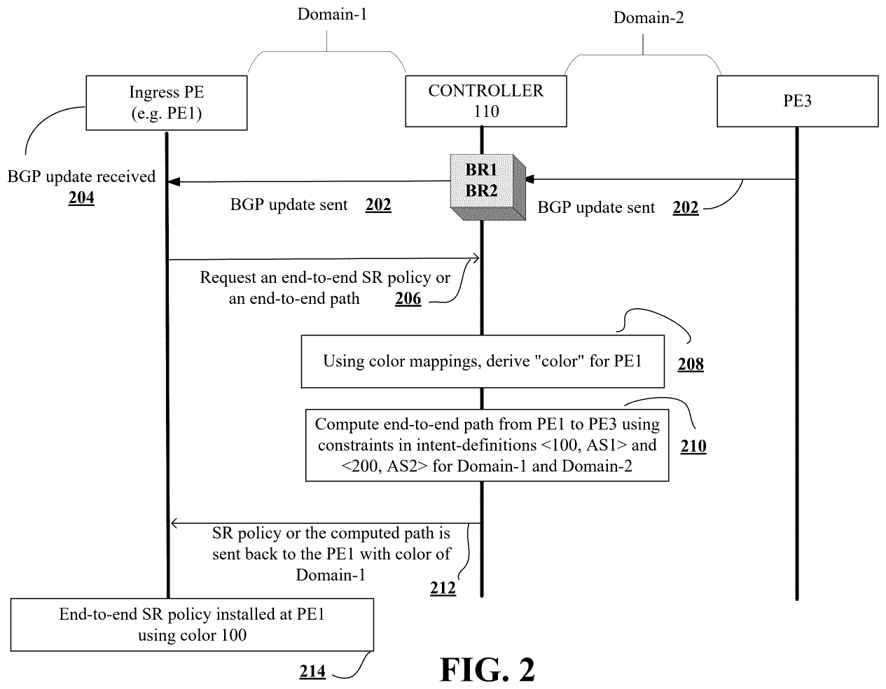

FIG. 2 depicts an illustrative embodiment of controller operations in accordance with various aspects described herein. As described above in connection with FIG. 1, the controller 110 accommodates different colors and intent definitions for different domains using ANR to provision the end-to-end transport. The color mapping server 120 reside within the controller 110, as depicted in FIG. 1. As one example, CE3 advertises prefix 10.3.1.0/24 to PE3 which triggers BGP updates. BGP updates are messages sent to advertise routing information, such as prefixes and path attributes, or to withdraw previously advertised routes. The update messages include the Network Layer Reachability Information (NLRI) that includes the prefix and associated BGP peers when advertising prefixes. As another example, a BGP VPNv4 update including prefix and color (e.g., pfx=10.3.1.0/24, color=200) is sent to the ingress PE (e.g., PE1) via the border routers, BR1 and BR2 (Act 202).

The border routers BR1 and BR2 transmit the BGP VPNv4 update to PE1 (Act 204) and another router PE2. When PE1 (i.e., the ingress-PE) receives the BGP update, PE1 will request an end-to-end SR policy or an end-to-end path from the controller 110 (Act 206). The end-to-end SR policy includes a list of instructions that specify a source-routed path and traffic flow for the end-to-end path. SR policy uses segment routing (SR) to allow a headend node to steer traffic along any path. When packets are steered into a SR policy, packets carry the ordered list of segments associated with that policy. The request to the controller 110 may include color=200, domain=AS2, and any other parameters that are required by the protocol (e.g., PCEP) used. The controller 110 then derives “Color 100” as the color for Domain-1 using color mappings (Act 208). When the controller 110 computes the path from PE1 to PE3, the controller 110 will use constraints in intent-definitions <100, AS1> and <200, AS2> for Domain-1 and Domain-2, respectively (Act 210). When the SR policy or the computed path is sent back to the PE1, color of Domain-1 (i.e., 100) is also sent to PE1 (Act 212). End-to-end SR policy is installed at PE1 using color 100 (Act 214). Color values in the BGP updates are not modified by the border routers BR1, BR2 as the BGP updates propagate in the network.

As depicted in FIG. 2, Domain-1 and Domain-2 may use different colors for a given intent. For instance, Domain-2 uses “color=200,” whereas Domain-1 uses “color=100,” with respect to the same intent. Domain-1 and Domain-2 may be controlled by a single authority rather than multiple operators. Color mapping between colors and domains are maintained at the color mapping server 120 and domains can be identified by AS numbers or by other parameters of domains.

FIG. 3 is another network diagram illustrating an exemplary, non-limiting embodiment of a controller-based multiple domain automatic next-hop resolution (ANR) in accordance with various aspects described herein. In various embodiments, a network 300 includes two autonomous systems, AS1 and AS2, which correspond to Domain-1 and Domain-2, respectively. The network 300 further includes customer edge routers CE1, CE2, CE3 and CE4, and provider edge routers PE1, PE2, PE3 and PE4. The Domain-1 and Domain-2 in the network 300 are connected via border node routers BR1 and BR2. The border node routers BR1 and BR2 can be implemented with an autonomous system boundary router (ASBR). As depicted in FIG. 3, customer sites (i.e., CE1, CE2, CE3, CE4) are connected to provider sites (PE1, PE2, PE3, PE4).

In various embodiments, the network 300 includes Controller 3 which includes a color mapping server 315. Controller 3 can be implemented as path computation element (PCE) and contains PCE functionality. Controller 3 can prepare and generate end-to-end SR policy paths across multiple domains and provide end-to-end disjoint paths, and enhance by eliminating BGP LU. As one example, Controller 3 can be implemented with computing environment as described below in connection with FIG. 8 as described in detail below.

In various embodiments, the network 300 further includes a plurality of controllers, such as Controller 1 through Controller 3. Although FIG. 3 illustrates three controllers, the present disclosure is not limited thereto. More controllers can be arranged to be paired with domains. Additionally, or alternatively, two or more controllers can be arranged to be paired with each domain. The two or more controllers corresponding to a single domain may form or establish hierarchical relationships or perform processing load balancing with certain percentage. As depicted in FIG. 3, Controller 3 and Controller 1 and Controller 2 operate as a set of hierarchical controllers. For instance, Controller 3 is a parent controller or a central controller and Controller 1 and Controller 2 are children controllers or sub-controllers. Controller 3 is in communication with Controller 1 and Controller 2 and provides commands to Controller 1 and Controller 2.

In various embodiments, Controllers 1 and 2 store intent definitions. By way of example only, intent (e.g., a requirement, a constraint, etc.) is to setup a transport from CE1 to access 10.3.1.0/24 network at CE3, without traversing a first link 322 (i.e., link between PE1 and BR1) and a second link 332 (i.e., link between BR1 and PE3). As another example, PE3 has been configured to advertise a VPNv4 route for prefix 10.3.1.0/24 with “Color 200.” As depicted in FIG. 3, intent definitions such as “<100, AS1> excludes srlg1”, “<200, AS2> exclude srlg2”, etc. are stored at a respective controller of each domain, i.e., Controller 1 for Domain-1 and Controller 2 for Domain-2.

In various embodiments, the network 300 is configured such that each domain (i.e., Domain-1, Domain-2) defines its own intent definition and a color. For a given color, each domain can define its own intent definition including a set of constraints and parameters based on the conventions used for configuring the domain. This intent definition will be used for computing SR policies or paths for SR policies by Controller 3 over the domain. By way of example only, these domain specific intent definitions could be identified by <color, domain>. Color mappings could be in the form of <color 1, domain 1>maps to <color 2, domain 2>maps to <color 3, domain 3>, and so on. Domain could be identified by the AS number or by other parameters of the domain, such as <100, AS1>, <200, AS2>, etc. As depicted in FIG. 3, the color mapping server 315 stores color mappings, such as <100, AS1>, <200, AS2>, etc. The color mapping server 315 is stored and maintained at Controller 3.

In various embodiments, for a given intent, each domain may use its own color. The color mapping server 315 resides within Controller 3 and maintain mappings between colors. When a transport across multiple domains is setup, color advertised by an egress-PE (e.g., PE3) via a BGP update is specific only to the domain which the egress-PE (e.g., PE3) belongs to. Other domains over which the transport is setup could have different colors that are mapped to the color advertised by the egress-PE (e.g., PE3). In other words, color associated with the same intent may vary based on domains (e.g., “200”for Domain-2 and “100”for Domain-1).

Referring back to FIG. 3, a non-limiting exemplary sequence of events in the network 300 is as follows. As depicted in FIG. 3, as one example, CE3 advertises prefix 10.3.1.0/24 to PE3. BGP updates are messages sent to advertise routing information, such as prefixes and path attributes, or to withdraw previously advertised routes. As another example, a BGP VPNv4 update including prefix and color (e.g., pfx=10.3.1.0/24, color=200) is sent to the border routers BR1 and BR2. The border routers BR1 and BR2 transmit the BGP VPNv4 update to PE1 and PE2.
Step 1: Ingress-PE (i.e., PE1) requests an end-to-end SR policy from Controller 1 by sending the received color 200, the egress-PE domain number of AS2, and a destination address.
Step 2: Controller 1 determines that the destination is not within Domain-1. Hence, Controller 1 forwards the request to Controller 3.
Step-3: Controller 3 determines color value of “100” for Domain-1 based on the color mappings, and requests a path from Controller 1 over Domain-1 by sending a request with color 100.
Step-4: Controller 3 determines color value of “200” for domain 2, and requests a path from Controller 2 over Domain-2 by sending a request with color 200.
Step-5: Controller 1 computes a path using a first intent-definition for color 100, and send the computed first path to Controller 3.
Step-6: Controller 2 computes a path using a second intent-definition for color 200, and send the computed second path to Controller 3.
Step-7: Controller 3 composes the end-to-end SR policy using the received first and second paths from the controllers 1 and 2, and send the SR policy along with the ingress-PE's domain color (i.e., color 100) to Controller 1.
Step-8: Controller 1 forwards the received SR policy to PE1 to be installed using color 100.

Based on the above, the ANR mechanism utilized in the network 300 can provision transport over multiple domains overcoming the problems that are associated with conventional ANR mechanisms. As described above, the conventional ANR mechanism does not allow the same color value to be used across all the domains as a color value advertised by the egress-PE might have already been used for a service with a different intent in another domain. The same intent definition may not be used to represent an intent across all domains because different domains, owned by different network operators, can be configured using different conventions. In the network 300, Controller 3 provide a different color value corresponding to intent/a color value advertised by an egress provider edge router (egress-PE) to the controllers 1 and 2 which are configured to handle and assigned to each of different domains. Then, each controller computes paths using a respective intent definition corresponding to and/or represented by the color value and sends each computed path to Controller 3. As a result, Controller 3 can compose the end-to-end SR policy using the received paths and send the SR policy along with the ingress-PE's domain color to Controller 1 or 2. The SR policy can be installed at the ingress-PE using the color value.

In the network 300, multiple domains can have different intent definitions represented by different colors. The controllers 1 and 2, assigned to each of the multiple domains, access and compute the paths based on respective defined intentions.

FIG. 4 depicts an illustrative embodiment of controller operations in accordance with various aspects described herein. As described above in connection with FIG. 3, the controllers 1, 2 and 3 accommodate different colors and intent definitions for different domains using ANR to provision the end-to-end transport. The controllers 1, 2 and 3 operate as a set of hierarchical controllers. The color mapping server 315 resides within Controller 3 which serves as a parent controller. Intent-definitions for each domain are configured at controller 1 and 2 with respect to each domain. In some embodiments, each domain is run and operated by a different operator having different authority. Intent-definitions, configuration and color values in each domain may differ and vary. The controllers 1 and 2 serve as a child controller, a local controller, and/or a domain specific controller. Controller 3 serves as a centralized controller, a main controller, and/or a multi-domain controller. For this reason, the color mapping server 315 resides at Controller 3.

In various embodiments, as depicted in FIG. 4, a provider edge router PE3 transmits BGP updates to border routers BR1 and BR2 (Acts 402). Using the example shown in FIG. 3, the BGP updates includes the prefix and the color value (e.g. 200) along with a destination address. The border routers BR1 and BR2 send the BGP request toward an ingress-PE (e.g., PE1) (Act 404). The ingress-PE (e.g., PE1) requests a SR policy or a path for a SR policy from Controller 1 by sending the received color (i.e., 200), the egress-PE domain number (e.g., AS number), and the destination address to Controller 1 (Act 406). Controller 1 determines that the destination is not within Domain-1 and forward the request to Controller 3 (Act 407). Controller 3 determines that a corresponding color value for <200, AS2>in Domain-1 is “100” for Domain-1 based on color mappings maintained in the color mapping server 315 (Act 409). Controller 3 requests a first path from Controller 1 over Domain-1 by sending the request with the corresponding color value (i.e., “100”) to Controller 1 (Act 408).

In various embodiments, Controller 3 determines that the color value for <200, AS2>belongs to Domain-2 and requests a second path from Controller 2 over Domain-2 by sending the request with the color (“200”) to Controller 2 (Act 410). Controller 1 computes the first path using intent-definition for color 100, which is configured in Domain-1, and sends the computed first path to Controller 3 (Act 412). Controller 2 computes the second path using intent-definition for color 200, which is configured in Domain-2, and sends the computed second path to Controller 3 (Act 414). Controller 3 composes an end-to-end SR policy using received first path and second path (Act 416) and forwards to Controller 1 (Act 418). The ingress-PE (e.g., PE1) installs the received SR policy using the corresponding color (“100”).

As described in the above embodiments, in connection with FIGS. 1-4, the ANR mechanisms can provision transport over multiple domains, regardless of whether different intent definitions and/or colors are configured in multiple domains. The controller or the parent controller of hierarchical controllers maintain the color-mapping server, where the color-mapping server maintains mappings between colors belonging to different domains and domains. The controller manages an intent-definition for each color of each domain. In embodiments using the hierarchical controllers, each child controller maintains intent-definitions for colors belonging to its domain. In the hierarchical controller embodiments, the parent controller requests a path from a child controller by sending color value of child controller's domain. This color value is retrieved from the color-mapping server at the parent controller.

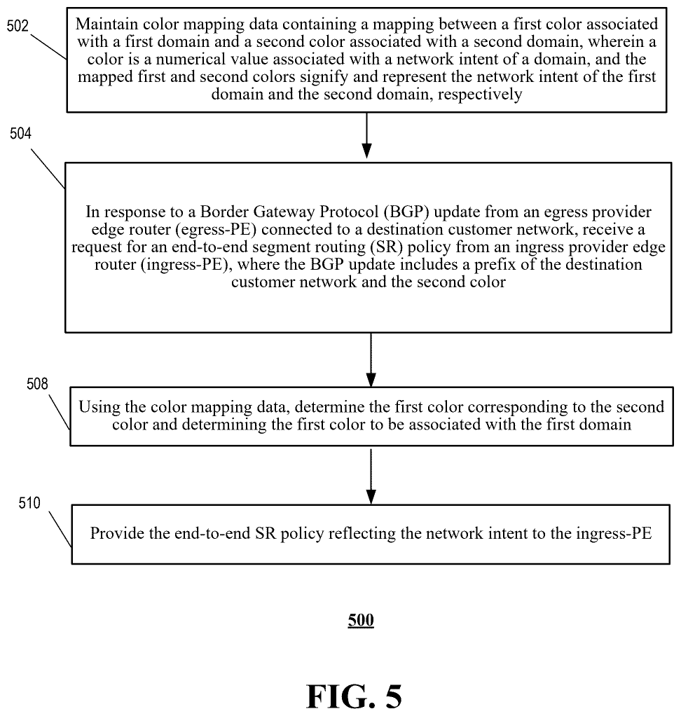

FIG. 5 depicts an illustrative embodiment of a method 500 in accordance with various aspects described herein. In various embodiments, the method 500 includes maintaining color mapping data containing a mapping between a first color associated with a first domain and a second color associated with a second domain, wherein a color is a numerical value associated with a network intent of a domain, and the mapped first and second colors signify and represent the network intent of the first domain and the second domain, respectively (Step 502), in response to a Border Gateway Protocol (BGP) update from an egress provider edge router (egress-PE) connected to a destination customer network, receiving a request for an end-to-end segment routing (SR) policy from an ingress provider edge router (ingress-PE), where the BGP update includes a prefix of the destination customer network and the second color, in response to the BGP update (Step 504) (Step 506), using the color mapping data, determining the first color corresponding to the second color and determining the first color to be associated with the first domain (Step 508), and providing the end-to-end SR policy reflecting the network intent to the ingress-PE (Step 510).

In various embodiments, the method 500 further includes computing the end-to-end SR policy using constraints defined by the network intent in connection with the first domain and the second domain. The end-to-end SR policy is installed at the ingress-PE using the first color. The BGP update is not modified by border routers and propagates across the first domain and the second domain.

In various embodiments, the method 500 is performed using a controller which is configured to perform path computation element (PCE) functionality. The method 500 further includes receiving one or more parameters that are required by a PCE protocol (PCEP) from the ingress-PE. The controller includes a set of hierarchical controllers including: a first controller associated with the first domain, a second controller associated with a second domain, and a third controller in communication with the first controller and the second controller and configured to maintain the color mapping data. The third controller operates as a parent controller and the first controller and the second controller operate as a child controller. The first controller requests the third controller to send a mapped color in response to the BGP update received at the ingress-PE and including the second color, upon determination that a destination of the BGP update is not within the first domain. Additionally, the first controller requests the third controller to provide the end-to-end SR policy in response to the BGP update received at the ingress-PE and including the second color, and upon determination that a destination of the end-to-end SR policy is not within the first domain.

In various embodiments, the method 500 further include maintaining a first network intent definition configured to achieve the network intent of the first domain at the first controller, and maintaining a second network intent definition configured to achieve the network intent of the second domain at the second controller. The method 500 further include computing, with the first controller, a first path using the first network intent definition associated with the first domain, computing, with the second controller, a second path using the second network intent definition associated with the second domain, and transmitting the first path and the second path to the third controller. The operations further include composing, with the third controller, the end-to-end SR policy using the first path and the second path and sending the composed end-to-end SR policy to the ingress-PE via the first controller.

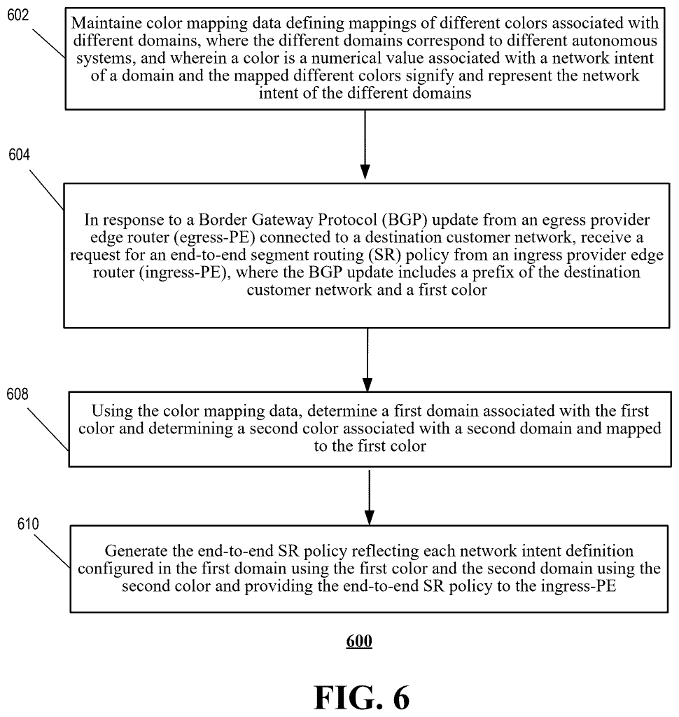

FIG. 6 depicts an illustrative embodiment of another method 600 in accordance with various aspects described herein. In various embodiments, the method 600 includes maintaining color mapping data defining mappings of different colors associated with different domains, wherein the different domains correspond to different autonomous systems, and wherein a color is a numerical value associated with a network intent of a domain and the different colors are mapped to be used as keys to identify each corresponding the network intent of the different domains (Step 602), in response to a Border Gateway Protocol (BGP) update from an egress provider edge router (egress-PE) connected to a destination customer network, receiving a request for an end-to-end segment routing (SR) policy indicative of an end-to-end path from an ingress provider edge router (ingress-PE), where the BGP update includes a prefix of the destination customer network and a first color, in response to the BGP update (Step 604), using the color mapping data, determining a first domain associated with the first color and determining a second color to be associated with a second domain mapped to the first color (Step 608), and generating the end-to-end SR policy reflecting each network intent definition configured in the first domain using the first color and the second domain using the second color and providing the end-to-end SR policy to the ingress-PE (Step 610).

In various embodiments, the method 600 further include storing network intent definitions of the different domains, identified by each of the different colors, wherein each of the network intent definitions contains one or more requirements or constraints configured to be customized for each different domain and computing the end-to-end SR policy by reflecting the one or more requirements or constraints in the stored network intent definitions. The method 600 further include accessing the network intent definitions of the different domains represented by each of the different colors, wherein the accessing the network intent definitions further includes accessing a network intent definition of the first domain with a first controller assigned to the first domain and accessing a network intent definition of the second domain is with a second controller assigned to the second domain. In various embodiments, the method 600 further include computing a first path in the first domain using the first controller, and computing a second path in the second domain using the second controller. The first path reflects the one or more requirements or constraints configured to be customized for the first domain and the second path reflects the one or more requirements or constraints configured to be customized for the second domain. The generating the end-to-end SR policy further includes composing the end-to-end SR policy using the first path received from the first controller and the second path received from the second controller.

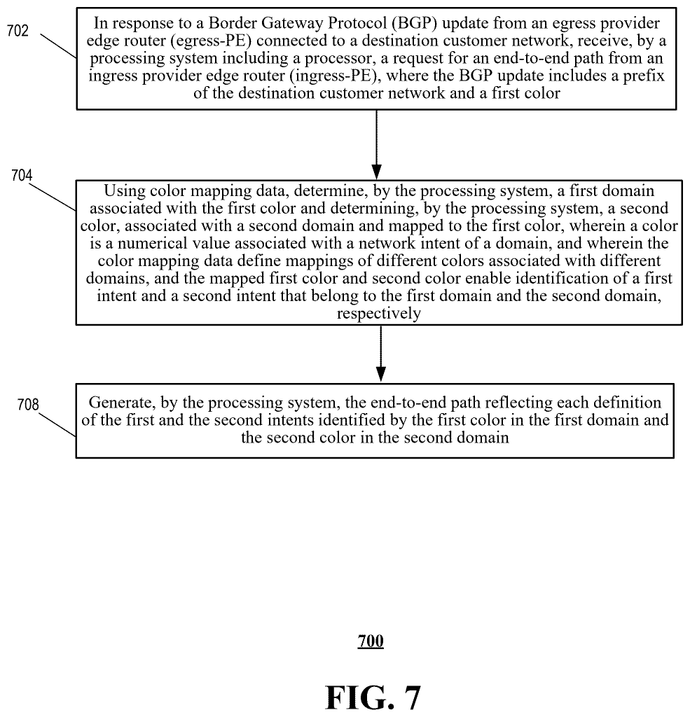

FIG. 7 depicts an illustrative embodiment of yet another method 700 in accordance with various aspects described herein. In various embodiments, the method 700 includes, in response to a Border Gateway Protocol (BGP) update from an egress provider edge router (egress-PE) connected to a destination customer network, receiving, by a processing system including a processor, a request for an end-to-end path from an ingress provider edge router (ingress-PE), wherein the BGP update includes a prefix of the destination customer network and a first color (Step 702), using color mapping data, determining, by the processing system, a first domain associated with the first color and determining, by the processing system, a second color, associated with a second domain and mapped to the first color, wherein a color is a numerical value associated with a network intent of a domain, and wherein the color mapping data define mappings of different colors associated with different domains, and the mapped different colors signify and represent a configured network intent of the different domains (Step 704), and generating, by the processing system, the end-to-end path reflecting the network intent represented by the first color in the first domain and the second color in the second domain (Step 708).

In various embodiments, the method 700 further includes storing, by the processing system, a first intent definition of the first domain and a second intent definition of the second domain, where the first intent definition contains a first set of requirements or constraints configured in the first domain, and the second intent definition contains a second set of requirements or constraints configured in the second domain. The first intent and the second intent are substantially identical. The method 700 also includes computing, by the processing system, the end-to-end path by reflecting the first set of requirements or constraints with respect to the first domain and the second set of requirements or constraints with respect to the second domain. The method 700 includes requesting, by the processing system, a first path in the first domain from a first controller assigned to the first domain, requesting, by the processing system, a second path in the second domain from a second controller assigned to the second domain, and generating the end-to-end path using the received first path and second path. The method 700 forwarding, by the processing system, the end-to-end path to the ingress-PE via the first controller such that the end-to-end path is installed at the ingress-PE using the first color.

While for purposes of simplicity of explanation, the respective processes are shown and described as a series of blocks in FIGS. 5-7, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

As described in the embodiments above, the present disclosure focusses on provisioning of end-to-end transport paths for ANR by a controller or a set of hierarchical controllers, where controllers are assumed to contain Path Computation Element (PCE) functionality; i.e., this proposal does not depend on Border Gateway Protocol Label Unicast (BGP LU). Use of controller/s is desirable as controller/s can compute end-to-end SR policy paths across multiple domains, able to provide end-to-end disjoint paths, and enhance scale by eliminating BGP LU.

Turning now to FIG. 8, there is illustrated a block diagram of a computing environment in accordance with various aspects described herein. In order to provide additional context for various embodiments of the embodiments described herein, FIG. 8 and the following discussion are intended to provide a brief, general description of a suitable computing environment 800 in which the various embodiments of the subject disclosure can be implemented. For example, computing environment 800 can facilitate in whole or in part systems and methods implementing controller-based multiple domain automatic next-hop resolution (ANR) in traffic engineering networks.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 8, the example environment can comprise a computer 802, the computer 802 comprising a processing unit 804, a system memory 806 and a system bus 808. The system bus 808 couples system components including, but not limited to, the system memory 806 to the processing unit 804. The processing unit 804 can be any of various commercially available processors. Dual microprocessors and other multiprocessor architectures can also be employed as the processing unit 804.

The system bus 808 can be any of several types of bus structure that can further interconnect to a memory bus (with or without a memory controller), a peripheral bus, and a local bus using any of a variety of commercially available bus architectures. The system memory 806 comprises ROM 810 and RAM 812. A basic input/output system (BIOS) can be stored in a non-volatile memory such as ROM, erasable programmable read only memory (EPROM), EEPROM, which BIOS contains the basic routines that help to transfer information between elements within the computer 802, such as during startup. The RAM 812 can also comprise a high-speed RAM such as static RAM for caching data.

The computer 802 further comprises an internal hard disk drive (HDD) 814 (e.g., EIDE, SATA), which internal HDD 814 can also be configured for external use in a suitable chassis (not shown), a magnetic floppy disk drive (FDD) 816, (e.g., to read from or write to a removable diskette 818) and an optical disk drive 820, (e.g., reading a CD-ROM disk 822 or, to read from or write to other high-capacity optical media such as the DVD). The HDD 814, magnetic FDD 816 and optical disk drive 820 can be connected to the system bus 808 by a hard disk drive interface 824, a magnetic disk drive interface 826 and an optical drive interface 828, respectively. The hard disk drive interface 824 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 802, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 812, comprising an operating system 830, one or more application programs 832, other program modules 834 and program data 836. All or portions of the operating system, applications, modules, and/or data can also be cached in the RAM 812. The systems and methods described herein can be implemented utilizing various commercially available operating systems or combinations of operating systems.

A user can enter commands and information into the computer 802 through one or more wired/wireless input devices, e.g., a keyboard 838 and a pointing device, such as a mouse 840. Other input devices (not shown) can comprise a microphone, an infrared (IR) remote control, a joystick, a game pad, a stylus pen, touch screen or the like. These and other input devices are often connected to the processing unit 804 through an input device interface 842 that can be coupled to the system bus 808, but can be connected by other interfaces, such as a parallel port, an IEEE 1394 serial port, a game port, a universal serial bus (USB) port, an IR interface, etc.

A monitor 844 or other type of display device can be also connected to the system bus 808 via an interface, such as a video adapter 846. It will also be appreciated that in alternative embodiments, a monitor 844 can also be any display device (e.g., another computer having a display, a smart phone, a tablet computer, etc.) for receiving display information associated with computer 802 via any communication means, including via the Internet and cloud-based networks. In addition to the monitor 844, a computer typically comprises other peripheral output devices (not shown), such as speakers, printers, etc.

The computer 802 can operate in a networked environment using logical connections via wired and/or wireless communications to one or more remote computers, such as a remote computer(s) 848. The remote computer(s) 848 can be a workstation, a server computer, a router, a personal computer, portable computer, microprocessor-based entertainment appliance, a peer device or other common network node, and typically comprises many or all of the elements described relative to the computer 802, although, for purposes of brevity, only a remote memory/storage device 850 is illustrated. The logical connections depicted comprise wired/wireless connectivity to a local area network (LAN) 852 and/or larger networks, e.g., a wide area network (WAN) 854. Such LAN and WAN networking environments are commonplace in offices and companies, and facilitate enterprise-wide computer networks, such as intranets, all of which can connect to a global communications network, e.g., the Internet.

When used in a LAN networking environment, the computer 802 can be connected to the LAN 852 through a wired and/or wireless communication network interface or adapter 856. The adapter 856 can facilitate wired or wireless communication to the LAN 852, which can also comprise a wireless AP disposed thereon for communicating with the adapter 856.

When used in a WAN networking environment, the computer 802 can comprise a modem 858 or can be connected to a communications server on the WAN 854 or has other means for establishing communications over the WAN 854, such as by way of the Internet. The modem 858, which can be internal or external and a wired or wireless device, can be connected to the system bus 808 via the input device interface 842. In a networked environment, program modules depicted relative to the computer 802 or portions thereof, can be stored in the remote memory/storage device 850. It will be appreciated that the network connections shown are example and other means of establishing a communications link between the computers can be used.

The computer 802 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10 BaseT wired Ethernet networks used in many offices.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data. Computer-readable storage media can comprise the widest variety of storage media including tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
maintaining color mapping data containing a mapping between a first color associated with a first domain and a second color associated with a second domain, wherein the first and second colors represent a network intent of the first domain and the second domain, respectively;
in response to a Border Gateway Protocol (BGP) update from an egress provider edge router (egress-PE) connected to a destination customer network, receiving a request for an end-to-end segment routing (SR) policy from an ingress provider edge router (ingress-PE), wherein the BGP update includes a prefix of the destination customer network and the second color;
using the color mapping data, determining the first color corresponding to the second color and determining the first color to be associated with the first domain; and
providing the end-to-end SR policy reflecting the network intent to the ingress-PE.

2. The device of claim 1, wherein the operations further comprise computing the end-to-end SR policy using constraints defined by the network intent in connection with the first domain and the second domain.

3. The device of claim 1, wherein the end-to-end SR policy is installed at the ingress-PE using the first color.

4. The device of claim 3, wherein the BGP update is not modified by border routers and propagates across the first domain and the second domain.

5. The device of claim 1, wherein the device is configured to perform path computation element (PCE) functionality; and
wherein the operations further comprise receiving one or more parameters that are required by a PCE protocol (PCEP) from the ingress-PE.

6. A system comprising a set of hierarchical controllers including:
a first controller associated with the first domain;
a second controller associated with a second domain; and
a third controller in communication with the first controller and the second controller and including the device of claim 1.

7. The system of claim 6, wherein the third controller operates as a parent controller and the first controller and the second controller operate as a child controller, and wherein the first controller requests the third controller to provide the end-to-end SR policy in response to the BGP update received at the ingress-PE and including the second color, and upon determination that a destination of the end-to-end SR policy is not within the first domain.

8. The system of claim 6, wherein the operations further comprise:
maintaining a first network intent definition configured to achieve the network intent of the first domain at the first controller; and
maintaining a second network intent definition configured to achieve the network intent of the second domain at the second controller.

9. The system of claim 8, wherein the operations further comprise:
computing, with the first controller, a first path using the first network intent definition associated with the first domain;
computing, with the second controller, a second path using the second network intent definition associated with the second domain; and
transmitting the first path and the second path to the third controller.

10. The system of claim 9, wherein the operations further comprise:
composing, with the third controller, the end-to-end SR policy using the first path and the second path; and
sending the composed end-to-end SR policy to the ingress-PE via the first controller.

11. A non-transitory machine-readable medium, comprising executable instructions that, when executed by a processing system including a processor, facilitate performance of operations, the operations comprising:
maintaining color mapping data defining mappings of different colors associated with different domains, wherein the different domains correspond to different autonomous systems, and wherein different colors are mapped to be used as keys to identify each corresponding network intent of the different domains;
in response to a Border Gateway Protocol (BGP) update from an egress provider edge router (egress-PE) connected to a destination customer network, receiving a request for an end-to-end segment routing (SR) policy indicative of an end-to-end path from an ingress provider edge router (ingress-PE), wherein the BGP update includes a prefix of the destination customer network and a first color;
using the color mapping data, determining a first domain associated with the first color and determining a second color to be associated with a second domain and mapped to the first color; and
generating the end-to-end SR policy reflecting each network intent definition configured in the first domain using the first color and configured in the second domain using the second color and providing the end-to-end SR policy to the ingress-PE.

12. The non-transitory machine-readable medium of claim 11, wherein the operations further comprise:
storing network intent definitions of the different domains, identified by each of the different colors, wherein each of the network intent definitions contains one or more requirements or constraints configured to be customized for each different domain; and
computing the end-to-end SR policy by reflecting the one or more requirements or constraints in the stored network intent definitions.

13. The non-transitory machine-readable medium of claim 11, wherein the operations further comprise accessing network intent definitions of the different domains identified by each of the different colors, wherein the accessing the network intent definitions further includes accessing a network intent definition of the first domain with a first controller assigned to the first domain and accessing a network intent definition of the second domain is with a second controller assigned to the second domain.

14. The non-transitory machine-readable medium of claim 13, wherein the operations further comprise:
computing a first path in the first domain using the first controller; and
computing a second path in the second domain using the second controller,
wherein the first path reflects one or more requirements or constraints configured to be customized for the first domain and the second path reflects the one or more requirements or constraints configured to be customized for the second domain.

15. The non-transitory machine-readable medium of claim 14, wherein the generating the end-to-end SR policy further comprises composing the end-to-end SR policy using the first path received from the first controller and the second path received from the second controller.

16. A method, comprising:
in response to a Border Gateway Protocol (BGP) update from an egress provider edge router (egress-PE) connected to a destination customer network, receiving, by a processing system including a processor, a request for an end-to-end path from an ingress provider edge router (ingress-PE), wherein the BGP update includes a prefix of the destination customer network and a first color;
using color mapping data, determining, by the processing system, a first domain associated with the first color and determining, by the processing system, a second color to be associated with a second domain and mapped to the first color, wherein the color mapping data define mappings of different colors associated with different domains, and the first color and the second color enable identification of a first intent and a second intent that belong to the first domain and the second domain, respectively; and
generating, by the processing system, the end-to-end path reflecting each definition of the first and the second intents identified by the first color in the first domain and the second color in the second domain.

17. The method of claim 16, further comprising:
storing, by the processing system, each definition of the first intent of the first domain and a second intent of the second domain, wherein the first intent definition contains a first set of requirements or constraints configured in the first domain, and the second intent definition contains a second set of requirements or constraints configured in the second domain, and wherein the first intent and the second intent are substantially identical; and
computing, by the processing system, the end-to-end path by reflecting the first set of requirements or constraints with respect to the first domain and the second set of requirements or constraints with respect to the second domain.

18. The method of claim 16, further comprising:
requesting, by the processing system, a first path in the first domain from a first controller assigned to the first domain; and
requesting, by the processing system, a second path in the second domain from a second controller assigned to the second domain.

19. The method of claim 18, further comprising:
receiving, by the processing system, the first path in the first domain computed by the first controller based on a first set of constraints or requirements contained in the definition of the first intent which is configured in the first domain ;
receiving, by the processing system, the second path in the second domain computed by the second controller based on a second set of constraints or requirements contained in the definition of the second intent which is configured in the second domain; and
generating the end-to-end path using the received first path and second path.

20. The method of claim 19, comprising:
forwarding, by the processing system, the end-to-end path to the ingress-PE via the first controller such that the end-to-end path is installed at the ingress-PE using the first color.
